(19) United States
(12) Patent Application Publication
(10) Pub. No.: US 2007/0096478 A1
(43) Pub. Date: May 3, 2007

(54) Security devices

(76) Inventor: Keith White, Oreston, Plymouth, Devon (GB)

Correspondence Address: MELVIN I. STOLTZ, ESQ., 51 CHERRY STREET, MILFORD, CT, 06460, US

(21) Appl. No.: 10/557,618

(22) PCT Filed: May 20, 2004
(86) PCT No.: PCT/GB04/02171

§ 371 Date: Jan. 3, 2007

(30) Foreign Application Priority Data
May 20, 2003 (GB) 0311522.7
Feb. 4, 2004 (GB) 0402410.5

(51) Int. Cl. E05C 19/18

(52) U.S. Cl. 292/288

(57) ABSTRACT

A security device for use in preventing unauthorized movement of a movable member relative to a fixed member includes: a) a bracket (10) for attachment to a presented surface of the fixed member, the bracket including a first element (12) which, in use, is disposed in face-to-face engagement with the presented surface of the fixed member, and a second element (14) which is formed with an aperture (15) or other engagement formation adjacent the end thereof remote from the first element (12), and b) an enlarged body (11) formed with a slot (16) to receive the end of the second element (14) in which the aperture (15) or other engagement formation is located, the enlarged body (11) being of such shape and configuration that, when the movable member is in its closed position relative to the fixed member and the enlarged body (11) is moved into a position such that the slot (16) therein receives the end of the second element 14), a part of the enlarged body (11) overlies a part of the movable member.

### FIELD OF THE INVENTION

This invention relates to security devices and, in particular, to security devices for preventing unauthorized opening of a door or drawer.

Various security devices are currently available for preventing children from obtaining access to a cupboard containing medicines or disinfectants, but the child-safety devices that are currently available are either difficult for some adults to open or too easy for some children to open.

It is accordingly an object of the present invention to provide an improved form of security device that can be used effectively for child-safety purposes.

It is another object of the present invention to provide an improved form of security device that can be used for a variety of purposes in addition to child safety.

It is a further object of the present invention to provide an improved method of preventing unauthorized opening of a door or drawer.

### SUMMARY OF THE INVENTION

According to a first aspect of the present invention there is provided a security device for use in preventing unauthorized movement of a movable member, such as a door or drawer, relative to a fixed member, such as a door frame or the frame of a cupboard, the security device including:—

a) a bracket for attachment to a presented surface of the fixed member, the bracket including a first element which, in use, is disposed in face-to-face engagement with the presented surface of the fixed member, and a second element which extends substantially perpendicularly to, or parallel to, the first element, the second element being formed with an aperture or other engagement formation adjacent the end thereof remote from the first element,

b) an enlarged body formed with a slot to receive the end of the second element in which the aperture or other engagement formation is located, the enlarged body being of such shape and configuration that, when the movable member is in its closed position relative to the fixed member and the enlarged body is moved into apposition such that the slot therein receives the end of the second element, a part of the enlarged body overlies a part of the movable member,

c) latch means within the enlarged body and arranged to engage the aperture or other engagement formation in the second element when the end of the second element is received in the slot, thereby holding the enlarged body in engagement with the bracket and serving to prevent movement of the movable member away from the fixed member, and

d) release means for releasing the latch means to permit disengagement of the enlarged body from the bracket, thereby permitting movement of the movable member away from the fixed member, the release means comprising a release element movable into engagement with the latch means in co-axial relation therewith such that, when the release element is in engagement with the latch means and rotation of the release element is effected, releasing movement of the latch means is effected.

According to a second aspect of the present invention there is provided a method of preventing unauthorized movement of a movable member, such as a door or drawer, relative to a fixed member, such as a door frame or the frame of a cupboard, the method including:—

a) providing a bracket for attachment to a presented surface of the fixed member, the bracket including a first element which, in use, is disposed in face-to-face engagement with the presented surface of the fixed member, and a second element which extends substantially perpendicularly to, or parallel to, the first element, the second element being formed with an aperture or other engagement formation adjacent the end thereof remote from the first element,

b) attaching the bracket to the presented surface of the fixed member,

c) providing an enlarged body formed with a slot to receive the end of the second element in which the aperture or other engagement formation is located, the enlarged body being of such shape and configuration that, when the movable member is in its closed position relative to the fixed member and the enlarged body is moved into a position such that the slot therein receives the end of the second element, a part of the enlarged body overlies a part of the movable member, and latch means being provided within the enlarged body and arranged to engage the aperture or other locating formation in the second element when the end of the second element is received in the slot, thereby holding the enlarged body in engagement with the bracket and serving to prevent movement of the movable member away from the fixed member,

d) engaging the enlarged body with the bracket, when the movable member is in its closed position relative to the fixed member, such that the slot in the enlarged body receives the end of the second element of the bracket and the latch means engages with the aperture or other engagement formation adjacent the end of the second element to hold the enlarged body in engagement with the bracket and thereby prevent movement of the movable member out of its closed position, and

e) providing release means that can be used, when so desired, to release the latch means and permit disengagement of the enlarged body from the bracket, thereby permitting movement of the movable member away from the fixed member, the release means comprising a release element movable into engagement with the latch means in co-axial relation therewith such that, when the release element is in engagement with the latch means and rotation of the release element is effected, releasing movement of the latch means is effected.

The latch means preferably includes a spring-loaded latch element having an inclined presented surface such that, when the enlarged body is moved into a position in which the second element of the bracket enters the slot in the enlarged body, the end of the second element of the bracket engages the inclined surface to displace the latch element against its spring-loading until the aperture in the second element is aligned with the latch element and the latch moves, under the action of its spring-loading into the aperture in the second element of the bracket to hold the enlarged body in engagement with the second element of the bracket.

The release means is preferably in the form of a key including a stem that can be inserted in a bore in the side of the enlarged body for engagement with the latch means to move the latch element against the action of its spring-loading so that the end of the latch element is no longer contained in the aperture in the second element of the bracket, the stem of the key including projections that engage in slots in the latch element.

### BRIEF DESCRIPTION OF THE DRAWINGS

FIG. 1 is a perspective view of a bracket,

FIG. 2 is an underneath plan view of an enlarged body, and

FIG. 3 is a part-sectional side view of the device in use.

### DESCRIPTION OF THE PREFERRED EMBODIMENT

The security device shown in the drawings is designed for use as a child-safety device for a cupboard door or drawer.

The device includes a metal bracket 10 and an enlarged body 11 formed of wood or as a plastic moulding. The bracket 10 includes a first planar element 12 that is formed with two apertures 13 for receiving screw-threaded fasteners (not shown) for securing the bracket 10 to the frame 25 of the cupboard adjacent an edge of a drawer or door 26. The bracket 10 also includes a second planar element 14 that extends at right angles to the plane of the first element 11 so that, when the bracket 10 is secured to the frame 25 of the cupboard, the second element 14 projects outwardly. An aperture 15 is formed in the second element 14 adjacent the end thereof remote from the first element 11.

The length of the second element 14 and the positioning of the aperture 15 are such that, when the bracket 10 is fixed in position, access can be obtained to the aperture 15, i.e. the aperture 15 is disposed outwardly of the presented surface of the drawer or door 26.

The enlarged body 11 is formed with a slot 16 that extends inwardly from a face 17 of the body 11 and the slot 16 communicates with a transverse bore 18 that contains a latch housing 19 within which there is a spring-loaded, generally cylindrical latch element 20. The slot 16 is of a size such that it can receive the end of the second element 14 of the bracket 10 and the arrangement is such that, when the enlarged body 11 is moved into a position in which the end of the second element 14 of the bracket 10 enters the slot 16, the end of the second element 14 engages an inclined end face of the latch element 20 to displace it against the action of its spring-loading.

With continued movement of the enlarged body 11 towards the frame to which the bracket 10 is attached, the displacement of the latch element 20 continues until the latch element 20 is aligned with the aperture 15 in the second element 14 of the bracket 10. The latch element 20 then moves, under the action of its spring-loading, so that the free end thereof enters the aperture 15 to hold the enlarged body 11 in engagement with the bracket 10. The size of the enlarged body 11 is such that, when it is moved into engagement with the bracket 10 with the drawer or door 26 in its closed position, a part of the enlarged body 11 will overlie an edge of the drawer or door 26 and will act as a blocking element preventing opening of the drawer or door 26.

It will be appreciated that, in order to lock the drawer or door 26 in its closed position, all that is required is movement of the enlarged body 11 into a position in which the end of the second element 14 of the bracket 10 enters the slot 16 and continued movement of the enlarged body 11 towards the frame 25 of the cupboard until the latch element 20 “clicks” into position in the aperture 15 in the second element 14 of the bracket 10.

When it is desired to effect authorised opening of the drawer or door, a key 27 is used. The key 27 includes a stem 29 that is inserted into the bore of the cylindrical latch element 20 contained in the bore 18 in the enlarged body 11. The stem 29 of the key 27 includes a pair of opposed projections 30 that fit in slots in the body of the cylindrical latch element 20. The stem 29 of the key 27 is then turned to withdraw the end of the latch element 20 from the aperture 15. This is again a very simple operation, but it requires the use of the key 27. The cylindrical wall of the latch element 20 is formed with an inclined groove 31 that co-operates with a transverse pin 32 such that, when the cylindrical latch element 20 is rotated by means of the key 27, axial movement of the latch element 20 is effected to move the end thereof clear of the surround of the aperture 15 in the second element 14 of the bracket 10.

The enlarged body 11 can be so produced that it has a visually attractive appearance and, although the invention has been described above with reference to its application to the secure closing of a cupboard door or drawer, it will be appreciated that there are many other purposes for which the device may be used.

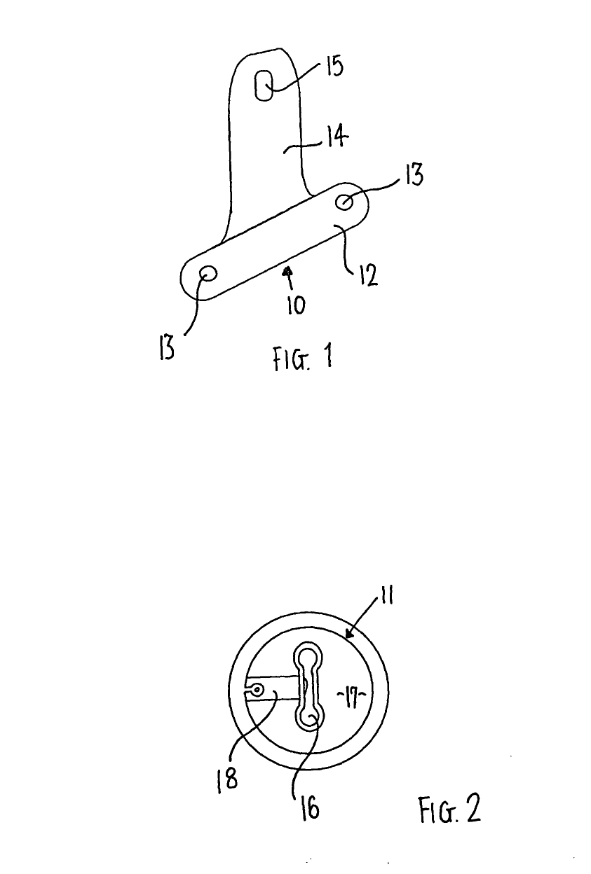

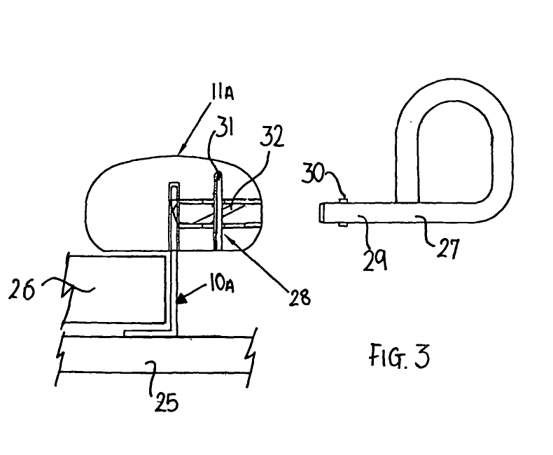

The configuration of the bracket 10 can differ from that shown in FIG. 1 and will depend on the configuration of the cupboard frame or other fixed member to which the bracket 10 is attached. Thus, the bracket can be of a generally T-shape, or of an L-shape or may comprise two portions that extend parallel to one another, either spaced from one another or having coinciding axes. Thus, where reference has been made above to the second element of the bracket extending parallel to the first element of the bracket, this includes an arrangement in which the bracket comprises a single metal strip, one end of which is attached to the frame and the other end of which is formed with an aperture, or other engagement formation, for engagement with the latch element.

The latch element 20 may include a part that is formed of an electromagnetic material and the release means for effecting release of the latch element may include a magnet.

The particular form of enlarged body 11 shown in the drawings is a separate element that can be engaged with the bracket 10 when a cupboard door is closed. The enlarged body 11 may, instead, be permanently secured to the door with the arrangement such that, when the door is moved into its closed position, the free end of the second element 14 of the bracket 10 enters the slot 16 in the enlarged body 11 and the latch element 20 within the enlarged body 11 engages the aperture 15 (or other locating formation of the bracket 10) to hold the door in its closed position until the latching action is released by the use of a key.

1. A security device for use in preventing unauthorized movement of a movable member, such as a door or drawer, relative to a fixed member, such as a door frame or the frame of a cupboard, the security device including:—
a) a bracket for attachment to a presented surface of the fixed member, the bracket including a first element which, in use, is disposed in face-to-face engagement with the presented surface of the fixed member, and a second element which extends substantially perpendicularly to, or parallel to, the first element, the second element being formed with an aperture or other engagement formation adjacent the end thereof remote from the first element,
b) an enlarged body formed with a slot to receive the end of the second element in which the aperture or other engagement formation is located, the enlarged body being of such shape and configuration that, when the movable member is in its closed position relative to the fixed member and the enlarged body is moved into a position such that the slot therein receives the end of the second element, a part of the enlarged body overlies a part of the movable member,
c) latch means within the enlarged body and arranged to engage the aperture or other engagement formation in the second element when the end of the second element is received in the slot, thereby holding the enlarged body in engagement with the bracket and serving to prevent movement of the movable member away from the fixed member, and
d) release means for releasing the latch means to permit disengagement of the enlarged body from the bracket, thereby permitting movement of the movable member away from the fixed member, the release means comprising a release element movable into engagement with the latch means in co-axial relation therewith such that, when the release element is in engagement with the latch means and rotation of the release element is effected, releasing movement of the latch means is effected.

2. A security device as claimed in claim 1, in which the latch means includes a spring-loaded latch element having an inclined presented surface such that, when the enlarged body is moved into a position in which the second element of the bracket enters the slot in the enlarged body, the end of the second element of the bracket engages the inclined surface to displace the latch element against its spring-loading until the aperture in the second element is aligned with the latch element and the latch element moves, under the action of its spring-loading, into the aperture in the second element of the bracket to hold the enlarged body in engagement with the second element of the bracket.

3. A security device as claimed in claim 2, in which the release means is in the form of a key having a stem that can be inserted in a bore in the side of the enlarged body for engagement with the latch means to move the latch element against the action of its spring-loading so that the end of the latch element is no longer contained in the aperture in the second element of the bracket, the stem of the key including projections that engage in slots in the latch element.

4. A method of preventing unauthorized movement of a movable member, such as a door or drawer, relative to a fixed member, such as a door frame or the frame of a cupboard, the method including:—
a) providing a bracket for attachment to a presented surface of the fixed member, the bracket including a first element which, in use, is disposed in face-to-face engagement with the presented surface of the fixed member, and a second element which extends substantially perpendicularly to, or parallel to, the first element, the second element being formed with an aperture or other engagement formation adjacent the end thereof remote from the first element,
b) attaching the bracket to the presented surface of the fixed member,
c) providing an enlarged body formed with a slot to receive the end of the second element in which the aperture or other engagement formation is located, the enlarged body being of such shape and configuration that, when the movable member is in its closed position relative to the fixed member and the enlarged body is moved into a position such that the slot therein receives the end of the second element, a part of the enlarged body overlies a part of the movable member, and latch means being provided within the enlarged body and arranged to engage the aperture or other locating formation in the second element when the end of the second element is received in the slot, thereby holding the enlarged body in engagement with the bracket and serving to prevent movement of the movable member away from the fixed member,
d) engaging the enlarged body with the bracket, when the movable member is in its closed position relative to the fixed member, such that the slot in the enlarged body receives the end of the second element of the bracket and the latch means engages with the aperture or other engagement formation adjacent the end of the second element to hold the enlarged body in engagement with the bracket and thereby prevent movement of the movable member out of its closed position, and
e) providing release means that can be used, when so desired, to release the latch means and permit disengagement of the enlarged body from the bracket, thereby permitting movement of the movable member away from the fixed member, the release means comprising a release element movable into engagement with the latch means in co-axial relation therewith such that, when the release element is in engagement with the latch means and rotation of the release element is effected, releasing movement of the latch means is effected.

5. A method as claimed in claim 4, in which the latch means includes a spring-loaded latch element having an inclined presented surface and in which, when the enlarged body is moved into a position in which the second element of the bracket enters the slot in the enlarged body, the end of the second element of the bracket engages the inclined surface to displace the latch element against its spring-loading until the aperture in the second element is aligned with the latch element and the latch moves, under the action of its spring-loading, into the aperture in the second element of the bracket to hold the enlarged body in engagement with the second element of the bracket.
